(19) United States
(12) Patent Application Publication
(10) Pub. No.: US 2026/0153813 A1
(43) Pub. Date: Jun. 4, 2026

(54) EXPOSURE DEVICE AND IMAGE FORMING APPARATUS INCLUDING EXPOSURE DEVICE

(71) Applicant: SHARP KABUSHIKI KAISHA, Osaka (JP)

(72) Inventors: MASAFUMI SAKAMOTO, Osaka (JP); HIROSHI YAMAMOTO, Osaka (JP); Katsuaki YAMADA, Osaka (JP); ATSUSHI UEDA, Osaka (JP); Akito TERAMOTO, Osaka (JP); KENZO OHKUBO, Osaka (JP); NORIAKI TAGUCHI, Osaka (JP)

(21) Appl. No.: 19/405,681

(22) Filed: Dec. 2, 2025

(30) Foreign Application Priority Data
Dec. 4, 2024 (JP) 2024-210907

(51) Int. Cl. G03G 15/043; G03G 15/00; G03G 15/04; G03G 21/12; G03G 21/16

(52) U.S. Cl. CPC G03G 15/043; G03G 15/0409; G03G 15/80; G03G 21/12; G03G 21/1647; G03G 2215/0412; G03G 2221/1618

(57) ABSTRACT

An exposure device that exposes an exposure target member, the exposure device includes: a substrate including one main surface on which a plurality of light-emitting elements are arranged in a substantially linear shape; a support member; and an optical holding member holding an optical member, and being provided on the one main surface side of the substrate, wherein the optical holding member is positioned at the support member while sandwiching the substrate between the support member and the optical holding member, and a first positioning portion that positions the optical holding member with respect to the exposure target member and a second positioning portion that positions the optical holding member with respect to the support member are provided to the optical holding member at positions outward of both ends of the optical member in the longitudinal direction of the optical member.

### CROSS-REFERENCE TO RELATED APPLICATION

The present application claims priority from Japanese Application JP2024-210907, the content to which is hereby incorporated by reference into this application.

### BACKGROUND OF THE INVENTION

### 1. Field of the Invention

The present disclosure relates to an exposure device and an image forming apparatus including the exposure device, in particular, an exposure device that exposes an exposure target member such as an image carrier in an electrophotographic image forming apparatus, and an image forming apparatus including the exposure device.

### 2. Description of the Related Art

As an exposure device of an electrophotographic image forming apparatus, there is known a type that employs a so-called light-emitting element array in which a plurality of light-emitting elements are arranged in a substantially linear shape. For example, in the related art, a technique has been known in which an LED array serving as the light-emitting element array is mounted on a printed wiring board, and light emitted from the LED array is imaged (radiated) onto a photoreceptor drum serving as an image carrier via a lens array in which a plurality of cylindrical rod lenses are formed. Note that the printed wiring board and the lens array are mounted to a common housing.

### SUMMARY OF THE INVENTION

In the related-art technique, when the rigidity of the printed wiring board is relatively high, the mutual distance between the LED array and the lens array can be controlled (managed) with high accuracy. However, when the rigidity of the printed wiring board is low, for example, when the printed wiring board is a sheet-like flexible printed circuit board, the mutual distance between the LED array and the lens array cannot be controlled with high accuracy. Accordingly, it is naturally impossible to control the mutual distance between the LED array and the photoreceptor drum with high accuracy as well. In recent years, in particular, an organic EL array in which a plurality of organic EL elements are arranged in a substantially linear shape is sometimes adopted as the light-emitting element array. In such a case, the organic EL array is provided generally on a flexible printed circuit (FPC). However, the related-art technique is not applicable in such a case.

In view of this, the present disclosure has an object to provide a novel technique in an exposure device that employs a flexible, sheet-like substrate on which a plurality of light-emitting elements arranged in a substantially linear shape are provided, and in an image forming apparatus including the exposure device, the novel technique being capable of controlling, with high accuracy, a mutual distance between an optical member including a plurality of lenses that image light emitted from the plurality of light-emitting elements onto an exposure target member and the plurality of light-emitting elements, and accordingly capable of controlling, with high accuracy, a mutual distance between the plurality of light-emitting elements and the exposure target member.

In order to achieve the object, the present disclosure includes a first disclosure relating to an exposure device and a second disclosure relating to an image forming apparatus including the exposure device.

Of the two disclosures, the first disclosure relating to the exposure device includes a substrate having a sheet-like shape, a support member, and an optical holding member. The substrate having a sheet-like shape has flexibility, and includes one main surface on which a plurality of light-emitting elements are arranged in a substantially linear shape. The support member is provided on the other main surface side of the substrate having a sheet-like shape. Further, the optical holding member holds an optical member formed of a plurality of lenses that image light emitted (radiated) from the plurality of light-emitting elements onto the exposure target member, and is provided on the one main surface side of the substrate having a sheet-like shape while a longitudinal direction of the optical member extends along an array direction of the plurality of light-emitting elements. At the same time, the optical holding member is positioned (fixed) at the support member while sandwiching the substrate having a sheet-like shape between the support member and the optical holding member. A first positioning portion and a second positioning portion are provided to the optical holding member at positions outward of both ends of the optical member in the longitudinal direction of the optical member. The first positioning portion is an element that positions the optical holding member with respect to the exposure target member, and the second positioning portion is an element that positions the optical holding member with respect to the support member.

Note that, for example, the first positioning portion includes a first protrusion and a second protrusion. The first protrusion is provided on one end side of the optical member in the optical holding member. The first protrusion protrudes in the imaging (radiation) direction of the light by the optical member, and extends along a direction orthogonal to both the imaging direction of the light and the longitudinal direction of the optical member. Further, the second protrusion is provided on the other end side of the optical member in the optical holding member. The second protrusion protrudes in the imaging direction of the light, and extends along the longitudinal direction of the optical member.

When the first positioning portion includes the first protrusion and the second protrusion, a displacement mechanism may further be provided. The displacement mechanism displaces a unit including the substrate, the support member, and the optical holding member along an extension direction of the first protrusion, in other words, a direction orthogonal to both the imaging direction of the light by the optical member and the longitudinal direction of the optical member.

In the present disclosure, the second disclosure relating to the image forming apparatus includes the exposure device of the first disclosure.

Note that, for example, the support member includes a rotation shaft and an inclined portion. The rotation shaft is provided on a side corresponding to one of both ends of the optical member, and protrudes in a direction orthogonal to both the longitudinal direction of the optical member and the imaging direction of the light by the optical member. Further, the inclined portion is provided on a side corresponding to the other of both ends of the optical member, and protrudes obliquely toward a side opposite to the side on which the substrate having a sheet-like shape is provided. Moreover, the image forming apparatus according to the second disclosure further includes an image carrier that serves as the exposure target member, a waste toner container, and a moving member. The waste toner container is removably attached to an image forming apparatus main body. Further, the moving member moves along the longitudinal direction of the optical member, in other words, an array direction of the plurality of light-emitting elements as the waste toner container is removed and attached with respect to the image forming apparatus main body. Herein, when the moving member moves as the waste toner container is mounted with respect to the image forming apparatus main body, the moving member abuts against the inclined portion, and the support member rotates about the rotation shaft as a rotation center. With this, positioning with respect to the image carrier by the first positioning portion may be achieved.

The inclined portion described herein may be formed of a spring having a plate-like shape.

According to the present disclosure, in an exposure device that employs a flexible, sheet-like substrate on which a plurality of light-emitting elements arranged in a substantially linear shape are provided, and in an image forming apparatus including the exposure device, a mutual distance between an optical member including a plurality of lenses that image light emitted from the plurality of light-emitting elements onto an exposure target member and the plurality of light-emitting elements can be controlled with high accuracy, and accordingly, a mutual distance between the plurality of light-emitting elements and the exposure target member can be controlled with high accuracy.

### BRIEF DESCRIPTION OF THE DRAWINGS

FIG. 1 is a diagram schematically illustrating an internal configuration of an image forming apparatus according to an example of the present disclosure.

FIGS. 2A and 2B are diagrams illustrating an external appearance of a substrate unit in the embodiment of the present disclosure.

FIG. 3 is a diagram for describing a mounting procedure of a support member to the substrate unit in the embodiment of the present disclosure.

FIG. 4 is a diagram illustrating a state in which the substrate unit in the embodiment of the present disclosure is mounted to the support member.

FIG. 5 is a diagram for describing a mounting procedure of the lens holder in the embodiment of the present disclosure to the support member.

FIGS. 6A to 6D are diagrams illustrating a configuration of the lens holder in the embodiment of the present disclosure.

FIGS. 7A and 7B are diagrams for describing a mounting procedure of the lens holder in the embodiment of the present disclosure to a positioning member.

FIG. 8 is a diagram illustrating the lens holder in the embodiment of the present disclosure is mounted to the support member.

FIG. 9 is a cross-sectional view in a vicinity of a center of an exposure unit main body in a front-rear direction in the embodiment of the present disclosure.

FIGS. 10A and 10B are diagrams illustrating an external appearance of an exposure unit in the embodiment of the present disclosure.

FIG. 11 is a diagram for describing a mounting procedure of the exposure unit in the embodiment of the present disclosure to an exposure device frame.

FIG. 12 is another diagram for describing the mounting procedure of the exposure unit in the embodiment of the present disclosure to the exposure device frame.

FIG. 13 is a diagram illustrating a state in which the exposure unit in the embodiment of the present disclosure is mounted to the exposure device frame.

FIG. 14 is another diagram illustrating a state in which the exposure unit in the embodiment of the present disclosure is mounted to the exposure device frame.

FIG. 15 is a diagram illustrating a mutual correlation between the positioning member of the exposure unit and a positioning engagement portion of a photoreceptor unit in the embodiment of the present disclosure.

FIGS. 16A and 16B are diagrams for describing a change in state of an exposure device with respect to the photoreceptor unit in the embodiment of the present disclosure.

FIGS. 17A and 17B are other diagrams for describing a change in state of the exposure device with respect to the photoreceptor unit in the embodiment of the present disclosure.

FIGS. 18A and 18B are other diagrams for further describing a change in state of the exposure device with respect to the photoreceptor unit in the embodiment of the present disclosure.

### DETAILED DESCRIPTION OF THE INVENTION

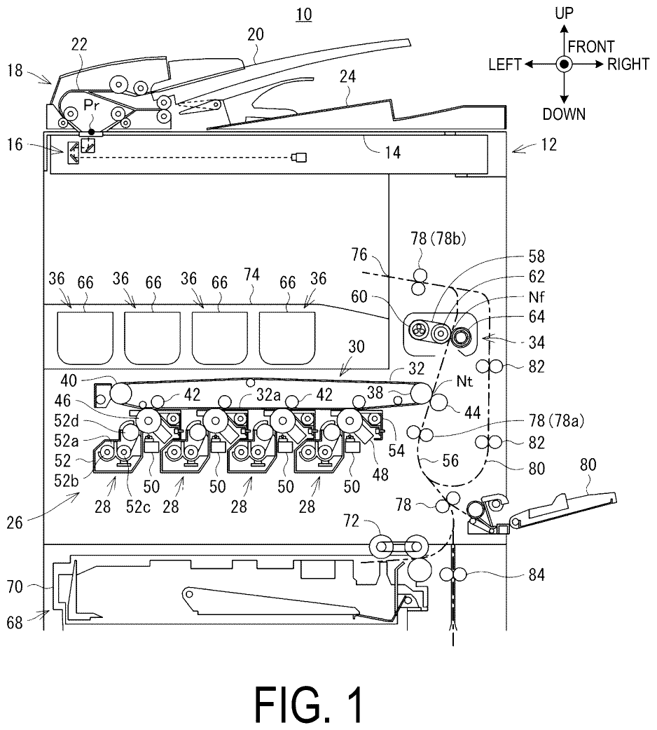

An embodiment of the present disclosure is described by using an image forming apparatus 10 illustrated in FIG. 1 as an example.

The image forming apparatus 10 according to the present first example is what is called a multifunction peripheral (MFP) having a plurality of functions such as a copy function, a print function, an image scanner function, and a fax function. FIG. 1 is a view of an internal configuration of the image forming apparatus 10 installed in a usable state, viewed from a front side of the image forming apparatus 10. In other words, an up-down direction in FIG. 1 corresponds to an up-down direction of the image forming apparatus 10. A left-right direction in FIG. 1 corresponds to a left-right direction of the image forming apparatus 10. Furthermore, a front side of the sheet surface in FIG. 1 corresponds to the front of the image forming apparatus 10. A back side of the sheet surface in FIG. 1 corresponds to the rear of the image forming apparatus 10.

An upper portion of the image forming apparatus 10 is provided with an image reader 12 as an image reading means. The image reader 12 performs image read processing of reading an image of a document (not illustrated) and outputting two-dimensional read image data corresponding to the image of the document. Therefore, the image reader 12 includes a document table 14 on which a document is placed. The document table 14 is formed of a transparent member such as glass having a substantially rectangular flat plate shape, and is provided so that both main surfaces thereof are arranged along a horizontal direction. An image reading unit 16 is provided below the document table 14. Although not described in detail, the image reading unit 16 includes a light source, a mirror, a lens, and a line sensor, and includes an image reading position Pr having a linear shape extending along a front-rear direction of the image forming apparatus 10 on an upper surface of the document table 14. Furthermore, a drive mechanism (not illustrated) that causes the image reading position Pr of the image reading unit 16 to move (scan) along the left-right direction of the image forming apparatus 10 is provided below the document table 14. In other words, when the image reading position Pr of the image reading unit 16 is moved by the drive mechanism in a state where a document is placed on the document table 14, an image of the document is read by what is called a fixed reading method. The front-rear direction of the image forming apparatus 10 is called a main scanning direction. The left-right direction of the image forming apparatus 10 is called a sub-scanning direction.

An automatic document feeder (ADF) 18 that also serves as a document pressing cover for pressing the document placed on the document table 14 is provided above the document table 14. The automatic document feeder 18 is provided so as to be able to transition between a state of exposing the upper surface of the document table 14 to the outside and a state of covering the upper surface of the document table 14. Therefore, the automatic document feeder 18 is joined to a main body (housing) of the image forming apparatus 10 via an appropriate movable support member such as a hinge (not illustrated). FIG. 1 illustrates a state where the automatic document feeder 18 covers the upper surface of the document table 14. The automatic document feeder 18 exhibits its original function when it is in a state of covering the upper surface of the document table 14 as illustrated in FIG. 1.

The automatic document feeder 18 includes a document placement tray 20 on which a plurality of sheet-like documents can be placed on. Although not described in detail, the automatic document feeder 18 takes in documents placed on the document placement tray 20 one by one (one document at a time), and conveys the documents on a document conveyance path 22 in the automatic document feeder 18. When a document conveyed along the document conveyance path 22 passes through the image reading position Pr, an image is read by the image reading unit 16, and is read in a so-called scan-through manner. Afterwards, the document is discharged to a document discharge tray 24.

An image former 26 as an image forming means is provided below the image reader 12. The image former 26 performs image formation processing of forming an image based on appropriate image data such as the above-described read image data onto a sheet-like image recording medium (not illustrated), for example, a paper sheet. In other words, the image former 26 performs printing. The image former 26 according to the present first embodiment employs a tandem-type electrophotographic process technique for color printing.

Specifically, the image former 26 includes four process units (also called “image forming stations”) 28, 28, . . . as monochrome toner image forming means that individually form monochrome toner images, not illustrated, of a plurality of different colors, for example, four colors of yellow, magenta, cyan, and black. At the same time, the image former 26 includes a transfer unit 30 as a transfer means. The transfer unit 30 includes an intermediate transfer belt 32 (also called a “primary transfer belt”) to which the monochrome toner images formed by the respective process units 28, 28, . . . are sequentially transferred, and transfers, onto a sheet, the toner image transferred to the intermediate transfer belt 32. Further, the image former 26 includes a fixing device 34 as a fixing means that fixes, on the sheet, the toner image transferred onto the sheet. Furthermore, the image former 26 includes four toner replenishment devices 36, 36, . . . that each individually replenish toner (not illustrated) to a corresponding one of development devices 52, 52, . . . (described later) of each of the process units 28, 28, . . .

First of all, the transfer unit 30 is described. The transfer unit 30 includes, in addition to the intermediate transfer belt 32 described above, a driving roller 38 that rotates the intermediate transfer belt 32, and a driven roller 40 that stretches the intermediate transfer belt 32 together with the driving roller 38. At the same time, the transfer unit 30 includes four intermediate transfer rollers (also called “primary transfer rollers”) 42, 42, . . . provided at positions corresponding to the respective process units 28, 28, . . . on an inner side of the intermediate transfer belt 32, and a transfer roller (also called “secondary transfer roller”) 44 as a transfer member.

The intermediate transfer belt 32 is stretched by the driving roller 38 and the driven roller 40. The driving roller 38 rotates by receiving a driving force from a motor as an intermediate transfer belt driving means (not illustrated), and rotates counterclockwise in FIG. 1, for example. Together with this, the intermediate transfer belt 32 rotates (circulates) in the same direction, and the driven roller 40 also rotates in the same direction. A region 32a on a lower side of the region between the driving roller 38 and the driven roller 40 in the intermediate transfer belt 32 is stretched along the horizontal direction, and the process units 28, 28, . . . are arranged to face the region 32a stretched along this horizontal direction. The region 32a where the process units 28, 28, . . . are arranged in the intermediate transfer belt 32 is called an intermediate transfer region. In this intermediate transfer region 32a, the intermediate transfer belt 32 moves from the left side to the right side of the image forming apparatus 10, in other words, along the sub-scanning direction.

The intermediate transfer belt 32 is an endless belt-type body having flexibility and is made of a synthetic resin (for example, polyimide or polycarbonate) to which a conductive material such as carbon black is appropriately mixed. Although not described in detail, the driven roller 40 also has a function of preventing looseness of the intermediate transfer belt 32 by applying appropriate tension to the intermediate transfer belt 32.

Next, each of the process units 28, 28, . . . is described. The process units 28, 28, . . . are provided at constant intervals below the intermediate transfer region 32a of the intermediate transfer belt 32 along the movement direction of the intermediate transfer belt 32 in the intermediate transfer region 32a, in other words, along the sub-scanning direction. As described above, the process units 28, 28, . . . each form, onto the intermediate transfer belt 32, an individual monochrome toner image of four colors of yellow, magenta, cyan, and black. Although not apparent from the drawings including FIG. 1, the process units 28, 28, . . . are provided in order of yellow, magenta, cyan, and black from the upstream side to the downstream side (from the left side to the right side in FIG. 1) in the movement direction of the intermediate transfer belt 32 in the intermediate transfer region 32a. However, this order is merely an example and is not limited thereto. The process units 28, 28, . . . have the same structure as each other, except for each forming a monochrome toner image of a different color on the intermediate transfer belt 32.

Each of the process units 28 includes a photoreceptor drum 46, a charging device 48, an exposure device 50, the development device 52, a cleaning device 54, a static elimination device (not illustrated), and the like.

The photoreceptor drum 46 (exposure target member) is an image carrier that carries an electrostatic latent image and a monochrome toner image described later, and includes a cylindrical base formed of a conductive material such as aluminum. Although omitted in the illustration, the base is grounded. On the surface (outer circumferential surface) thereof, a photosensitive layer having a property of exhibiting insulation when not irradiated with light and becoming conductive in a region irradiated with light is formed. The photoreceptor drum 46 is provided in the intermediate transfer region 32a so that the surface of the base abuts against the outer surface of the intermediate transfer belt 32, and the photoreceptor drum 46 rotates by receiving a driving force from a motor (not illustrated) serving as a drum driving means, and rotates clockwise in FIG. 1, specifically. Further, the photoreceptor drum 46 rotates at a speed corresponding to the moving speed of the intermediate transfer belt 32.

The charging device 48 is a charging means that charges the surface of the photoreceptor drum 46 to a predetermined potential, for example, −600 V. The surface of the photoreceptor drum 46 charged to the predetermined potential by the charging device 48 is exposed by the exposure device 50 as an exposure means.

Although details of the exposure device 50 will be described later, the exposure device 50 linearly exposes the surface of the photoreceptor drum 46 along the rotation axis direction of the photoreceptor drum 46, that is, along the main scanning direction. The exposed region of the surface of the photoreceptor drum 46 is lowered to a potential close to the ground potential (0 V). Note that the exposure device 50 is provided below the photoreceptor drum 46, and exposes the surface of the photoreceptor drum 46 from below. Further, the exposure device 50 is driven in a mode in accordance with image data provided for printing, in other words, irradiates the surface of the photoreceptor drum 46 with light in a mode in accordance with the image data. Thus, an electrostatic latent image having a surface potential changed in accordance with image data to be printed is formed on the surface of the photoreceptor drum 46.

The development device 52 is a development means that develops the electrostatic latent image formed on the surface of the photoreceptor drum 46. In other words, the development device 52 includes a developer accommodation chamber 52a, and this developer accommodation chamber 52a accommodates a developer containing toner. The developer accommodated in the developer accommodation chamber 52a is stirred and triboelectrically charged by stirring members 52b and 52c provided in the developer accommodation chamber 52a, and a part of the developer is supplied to a development roller 52d. A development power supply (not illustrated) that outputs a development bias having a predetermined voltage value (for example, −420 V) is connected to the development roller 52d. By a potential difference between the development bias supplied to the development roller 52d and an electrostatic latent image formed on the photoreceptor drum 46, toner on the development roller 52d is supplied to the photoreceptor drum 46, and the electrostatic latent image is developed with the toner. In other words, the electrostatic latent image formed on the photoreceptor drum 46 is visualized as a monochrome toner image by the toner contained in the developer accommodated in the development device 52 (developer accommodation chamber 52a). Note that the developer is a two-component developer containing a carrier in addition to toner, but it may be a one-component developer containing only toner.

The monochrome toner image formed on the surface of the photoreceptor drum 46 by development by the development device 52 is transferred from the surface of the photoreceptor drum 46 to the outer surface of the intermediate transfer belt 32 at a contact position between the surface of the photoreceptor drum 46 and the outer surface of the intermediate transfer belt 32, in other words, the monochrome toner image is transferred by so-called intermediate transfer (primary transfer). Therefore, an intermediate transfer roller 42 is provided so as to face the photoreceptor drums 46 across the intermediate transfer belt 32. The intermediate transfer roller 42 is provided so that a surface (outer circumferential surface) of the intermediate transfer roller 42 abuts against the inner surface of the intermediate transfer belt 32, and rotates by receiving a driving force generated by the rotation of the intermediate transfer belt 32, in other words, rotates counterclockwise in FIG. 1. When the intermediate transfer roller 42 is applied with a predetermined intermediate transfer voltage from an intermediate transfer power source (not illustrated), a transfer electric field is formed between the surface of the photoreceptor drum 46 and the outer surface of the intermediate transfer belt 32. By the action of this transfer electric field, the monochrome toner image on the photoreceptor drum 46 is transferred onto the intermediate transfer belt 32.

In this manner, monochrome toner images of the four colors of yellow, magenta, cyan, and black are individually formed on the intermediate transfer belt 32. A color toner image is formed on the intermediate transfer belt 32 by the monochrome toner images of the four colors being superimposed on each other.

The (color) toner image formed on the intermediate transfer belt 32 is transferred to a sheet at a transfer nip portion Nt which is a contact part between the intermediate transfer belt 32 and the transfer roller 44. Specifically, the transfer roller 44 is provided so as to press the intermediate transfer belt 32 between the transfer roller 44 and the driving roller 38 at a position facing the driving roller 38 across the intermediate transfer belt 32. The transfer roller 44 rotates by receiving a driving force generated by the rotation of the intermediate transfer belt 32, in other words, rotates clockwise in FIG. 1. Furthermore, a transfer bias current having the same polarity as the charging polarity of the toner is applied from a transfer bias power source (not illustrated) to the driving roller 39. Thus, a transfer electric field is formed between the intermediate transfer belt 32 and the transfer roller 44, in other words, at the transfer nip portion Nt. When the sheet passes through the transfer nip portion Nt in this state, the toner image on the intermediate transfer belt 32 is transferred onto the sheet.

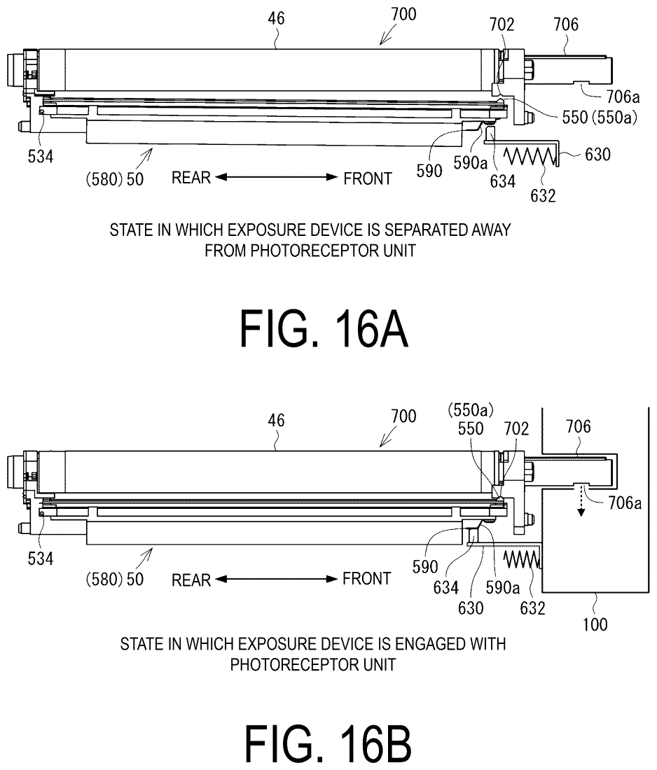

The cleaning device 54 is a cleaning means that removes residual toner on the photoreceptor drum 46 after the monochrome toner image is transferred from the photoreceptor drum 46 onto the intermediate transfer belt 32. Toner removed by the cleaning device 54, in other words, waste toner is discharged to a waste toner container 100, which is not illustrated in FIG. 1 (see FIG. 16B).

The static elimination device (not illustrated) is a static elimination means that removes static electricity on the photoreceptor drum 46 after the residual toner is removed by the cleaning device 54. After the electrostatic latent image is removed by the static elimination means, the process subsequent to the charging by the charging device 48 described above is repeated.

The fixing device 34 is provided downstream of the transfer nip portion Nt in a conveyance direction of the sheet conveyed along a sheet conveyance path 56 described later. As described above, the fixing device 34 fixes, on the sheet, the toner image on the sheet, specifically, heats and melts the toner image, and further presses the toner image, thereby fixing (thermally fixing) the toner image on the sheet. Therefore, the fixing device 34 includes a heating belt 58, a heating roller 60, a fixing roller 62, and a pressure roller 64.

The heating belt 58 is an endless belt-type body having flexibility and is made of a synthetic resin (for example, polyimide or polycarbonate) having high thermal conductivity. The heating belt 58 is stretched by the heating roller 60 and the fixing roller 62. The heating roller 60 includes a cylindrical base (heat conductive layer) having high thermal conductivity, and a heat source is provided inside thereof. The heat source is a lamp heater such as a halogen lamp, and is heated by receiving supply of heating power from a heater heating power source (not illustrated). The fixing roller 62 is a columnar roller member, and includes a metal core and an elastic layer covering the metal core. In other words, the heating roller 60 and the fixing roller 62 extend in parallel to each other, and stretch the heating belt 58, in other words, so as to be in contact with the inner surface of the heating belt 58. Further, the fixing roller 62 rotates by receiving a driving force from a motor as a heating belt driving means (not illustrated), and rotates counterclockwise in FIG. 1, for example. Together with this, the heating belt 58 rotates (circulates) in the same direction as the fixing roller 62, and the heating roller 60 also rotates in the same direction as the fixing roller 62.

The pressure roller 64 is a columnar roller member, and includes a metal core, an elastic layer covering the metal core, and a release layer covering the elastic layer. Further, the pressure roller 64 is provided so as to press the heating belt 58 between the pressure roller 64 and the fixing roller 62 at a position facing the fixing roller 62 across the heating belt 58. That is, the pressure roller 64 is provided so as to extend along a rotation axis direction of the fixing roller 62, in other words, so as to extend along the rotation axis direction of the heating belt 58. The pressure roller 64 rotates by receiving a driving force generated by the rotation of the heating belt 58, in other words, rotates clockwise in FIG. 1. A fixing nip portion Nf, which is a pressing part of the heating belt 58 by the pressure roller 64, is positioned in the sheet conveyance path 56 described later. When the sheet passes through the fixing nip portion Nf, the toner image on the sheet is heated and melted, further pressed, and fixed on the sheet.

Although not described in detail including drawings, the fixing device 34 includes a temperature sensor that detects a surface temperature (fixing temperature) of the heating belt 58. Based on a detection result by the temperature sensor, the heating temperature of the heating roller 60 by the above-described heat source is controlled, and thus, the surface temperature of the heating belt 58 is controlled. For example, a thermistor is used as the temperature sensor, but the temperature sensor is not limited thereto. Further, a configuration may be adopted as the fixing device 34 in which the fixing roller 62 also serves as the heating roller 60 without including the heating belt 58, and a direct contact portion between the fixing roller 62 and the pressure roller 64 is defined as the fixing nip portion Nf.

Each of the replenishment devices 36 supplies toner to the development device 52 corresponding thereto, specifically, to the developer accommodation chamber 52a of the development device 52. Thus, each of the replenishment devices 36 includes a toner cartridge mounting portion 66 to which a toner cartridge (not illustrated) accommodating toner of a corresponding color is mounted.

Furthermore, below the image former 26, in other words, at a lower portion in the image forming apparatus 10, a sheet feeder 68 is provided as a sheet feeding means. The sheet feeder 68 includes a sheet feeding cassette 70, and a plurality of sheets can be accommodated in this sheet feeding cassette 70 in a stacked manner. At the same time, the sheet feeder 68 includes a pickup roller 72. The sheet feeder 68 takes out, one by one, by the pickup roller 72, sheets accommodated in the sheet feeding cassette 70 and supplies the sheets to the sheet conveyance path 56.

The sheet conveyance path 56 is provided from the sheet feeder 68, via the transfer nip portion Nt and the fixing nip portion Nf, to a sheet discharge port 76 leading to a sheet discharge tray 74. Further, at appropriate positions of the sheet conveyance path 56, a plurality of conveyance rollers (strictly speaking, roller pairs) 78, 78, . . . that convey sheets along the sheet conveyance path 56 from the sheet feeder 68 toward the sheet discharge port 76 are provided. Note that, among the conveyance rollers 78, 78, . . . , a conveyance roller 78a provided at a position closest to the transfer nip portion Nt on an upstream side relative to the transfer nip portion Nt in the conveyance direction of the sheet in the sheet conveyance path 56 is a resist roller (also called “paper stop roller”) that measures a timing at which the sheet enters the transfer nip portion Nt. Further, among the conveyance rollers 78, 78, . . . , a conveyance roller 78b provided at the most distal downstream position in the conveyance direction of the sheet in the sheet conveyance path 56, in other words, in the vicinity of the sheet discharge port 76, is a sheet discharge roller that discharges the sheet to the sheet discharge tray 74 via the sheet discharge port 76. Note that the sheet discharge tray 74 is provided between the image reader 12 and the image former 26, in other words, provided in what is called an in-body space while not limited thereto.

In addition, a conveyance path 80 for double-sided printing is provided in the image forming apparatus 10. The conveyance path 80 for double-sided printing is a conveyance path for taking in a sheet having passed the fixing nip portion Nf, in other words, a printed sheet, and supplying the sheet to be printed again. In other words, the sheet taken into the conveyance path 80 for double-sided printing is supplied again to the sheet conveyance path 56 via the conveyance path 80, and more specifically, is supplied upstream of the resist roller 78a. Thus, the sheet supplied upstream of the resist roller 78a is brought into a state where the front and back of the sheet are reversed. Printing is performed on this sheet that has been turned over, and what is called double-sided printing is achieved. At an appropriate position of the conveyance path 80 for double-sided printing, a transfer roller (strictly speaking, a roller pair) 82 is also provided.

Further, on a right-side surface of the image forming apparatus 10, a manual feed tray 84 is provided. A plurality of sheets can be placed on the manual feed tray 84 in a stacked manner. When the manual feed tray 84 is designated as a sheet supply source, the sheet feeder 68 supplies sheets one by one from the manual feed tray 84 to the sheet conveyance path 56.

Moreover, the sheet feeder 68 may include an optional sheet feeding cassette (not illustrated). The optional sheet feeding cassette is provided below the sheet feeding cassette 70. When the optional sheet feeding cassette is designated as a sheet supply source, the sheet feeder 68 supplies sheets one by one from the optional sheet feeding cassette to the sheet conveyance path 56. An optional conveyance roller (strictly speaking, a roller pair) 84 that supplies a sheet from the optional sheet feeding cassette to the sheet conveyance path 56 is provided at an appropriate position.

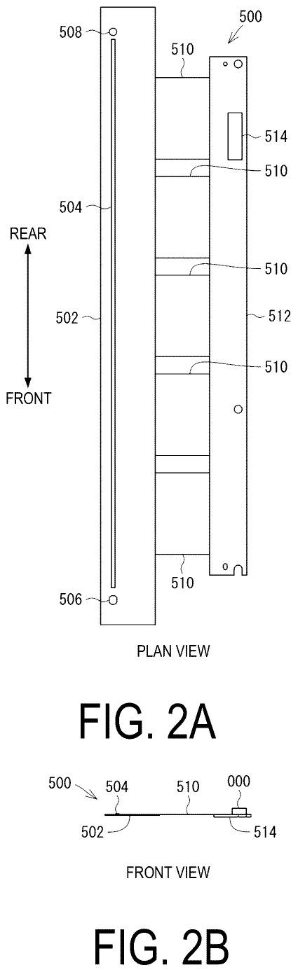

Next, the exposure device 50 according to the present first embodiment is described in detail. The exposure device 50 includes a substrate unit 500 as illustrated in FIGS. 2A and 2B. The substrate unit 500 includes a sheet-like substrate 502 having a flexible, elongated, substantially rectangular shape (that is, substantially belt-like shape). On one side edge (the left side edge in FIGS. 2A and 2BA) of the sheet-like substrate 502, on an upper surface which is one main surface, a light-emitting element array 504 in which a plurality of organic EL elements are arranged substantially linearly as light-emitting elements is provided. Note that, although it cannot be seen from the drawings including FIGS. 2A and 2B, the light-emitting element array 504 is a single-row organic EL array in which the organic EL elements forming the array are arranged in a single line. However, the light-emitting element array 504 may be a multi-row organic EL array in which the organic EL elements are arranged substantially linearly in two or more rows. Further, the sheet-like substrate 502 is a so-called flexible printed circuit board (FPC), in which, for example, on a transparent polyimide base material, the light-emitting element array 504 formed of a plurality of organic EL elements and wirings (signal lines) for the light-emitting element array 504 are formed. The thickness dimension of the sheet-like substrate 502 including the light-emitting element array 504 is 0.13 mm, for example.

The light-emitting element array 504 is provided so as to extend along the longitudinal direction of the sheet-like substrate 502, and is provided at a position closer to the one side edge (the left side edge in FIGS. 2A and 2B) of the sheet-like substrate 502 with respect to the center of the sheet-like substrate 502 in the width direction, which is the transverse direction of the sheet-like substrate 502. Furthermore, two positioning holes 506 and 508 are provided at appropriate positions outside both ends of the light-emitting element array 504 in the longitudinal direction of the sheet-like substrate 502, the positions being close to both ends of the light-emitting element array 504 on the extension line of the light-emitting element array 504 (the array of the plurality of organic EL elements). The two positioning holes 506 and 508 are elements for positioning when the substrate unit 500 including the sheet-like substrate 502 is mounted to a support member 520, which is described later. Note that, although details thereof are described later, the substrate unit 500 including the sheet-like substrate 502 is first mounted to the support member 520. Further, the exposure device 50 including the support member 520 and the substrate unit 500 mounted to the support member 520, is mounted to the image forming apparatus 10. In this state, for example, the lower part of the substrate unit 500, which is illustrated in FIG. 2A, is positioned on the front side of the image forming apparatus 10, and the upper part of the substrate unit 500, which is illustrated in FIG. 2A, is positioned on the rear side of the image forming apparatus 10. Herein, the positioning hole 508 positioned on the rear side is a perfect-circle hole, and the positioning hole 506 positioned on the front side is an elongated hole extending along the length direction of the sheet-like substrate 502, in other words, the front-rear direction of the image forming apparatus 10. The reason for providing the different hole shapes is described later.

Further, in FIGS. 2A and 2B, on the other side edge (the right-side edge in FIGS. 2A and 2B) of the sheet-like substrate 502, a driver board 512 having an elongated, substantially straight ruler-like shape is shown. The driver board 512 is provided with a driver circuit (not illustrated) for driving the light-emitting element array and a connector 514 that connects the driver circuit to a control circuit (not illustrated) provided to the main body of the image forming apparatus 10. The driver board 512 is formed of a material with high rigidity, for example, a glass epoxy resin, and is provided so as to extend along the extension direction of the sheet-like substrate 502, in other words, extend in parallel to the sheet-like substrate 502. Further, a plurality of signal lines 510, 510, . . . , in which wirings for connecting the light-emitting element array 504 and the driver circuit to each other are formed are provided between the sheet-like substrate 502 and the driver board 512, and the sheet-like substrate 502 and the driver board 512 are connected to each other in an integrated manner via the signal lines 510 and 510. Herein, the signal line (not illustrated) connected to the signal line 510 and the connector 514 has flexibility and a sheet-like shape and is formed of a flexible printed circuit (FPC) formed of polyimide, for example.

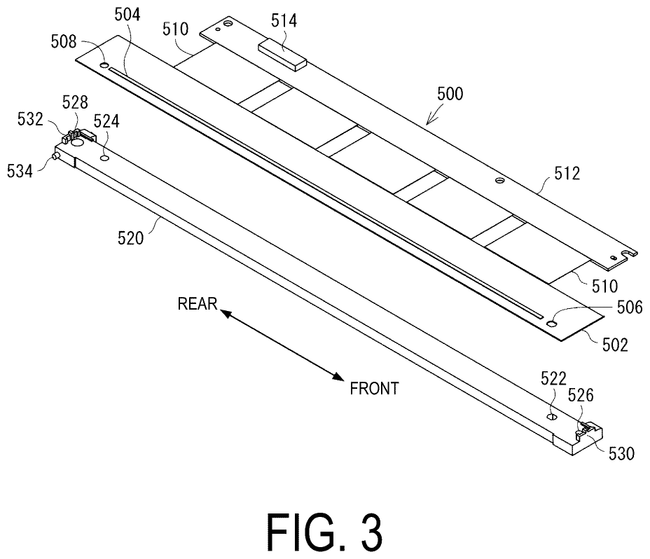

The sheet-like substrate 502 of the substrate unit 500, which is configured as described above, is mounted to the support member 520 illustrated in FIG. 3. The support member 520 is an elongated, substantially rectangular flat-plate member, and is, for example, a hard resin molded article. An upper surface being one main surface of the support member 520 (the upper main surface in FIG. 3) is a flat surface, and the sheet-like substrate 502 is mounted to the upper surface. Specifically, a bottom surface being the other main surface of the sheet-like substrate 502 is fixed by an adhesive (or a double-sided tape). In this state, the sheet-like substrate 502 is mounted to the support member 520 while the longitudinal direction of the sheet-like substrate 502 extends along with the longitudinal direction of the support member 520. Further, the support member 520 is provided with two positioning holes 522 and 524 corresponding to the two positioning holes 506 and 508 of the sheet-like substrate 502. When the substrate unit 500 including the sheet-like substrate 502 is mounted to the support member 520, positioning by the positioning holes 506, 508, 522, and 524 is performed.

In other words, when the substrate unit 500 including the sheet-like substrate 502 is mounted to the support member 520, a rod-shaped pin provided to a positioning assembly jig (not illustrated) is inserted into each of the positioning holes 522 and 524 of the support member 520. With this, the sheet-like substrate 502 is positioned with respect to the support 520. Specifically, the pin inserted into the positioning hole 522 on the front side of the support member 520 is inserted into the positioning hole 506 on the front side of the sheet-like substrate 502, and the pin inserted into the positioning hole 524 on the rear side of the support member 520 is inserted into the positioning hole 508 on the rear side of the sheet-like substrate 502. Then, while the respective pins are inserted into the positioning hole 522 on the front side and the positioning hole 524 on the rear side of the sheet-like substrate 502, the sheet-like substrate 502 is brought closer to the support member 520 side so that the bottom surface of the sheet-like substrate 502 abuts against the upper surface of the support member 520. With this, the sheet-like substrate 502 is bonded to the support member 520 by an adhesive. Consequently, the position of the positioning hole 522 on the front side of the support member 520 and the position of the positioning hole 506 on the front side of the sheet-like substrate 502 match with each other, and the position of the positioning hole 524 on the rear side of the support member 520 and the position of the positioning hole 508 on the rear side of the sheet-like substrate 502 match with each other. In other words, accurate positioning is performed. Note that the positioning hole 524 on the rear side of the support member 520 is a perfect-circle hole similarly to the positioning hole 508 on the rear side of the sheet-like substrate 502, and the positioning hole 522 on the front side of the support member 520 is an elongated hole extending along the front-rear direction of the image forming apparatus 10 similarly to the positioning hole 506 of the sheet-like substrate 502. Therefore, even when there is a light difference between the mutual distance between the two positioning holes 522 and 524 of the support member 520 and the mutual distance between the two positioning holes 506 and 508 of the sheet-like substrate 502, the difference, namely, a dimension error in the front-rear direction is absorbed.

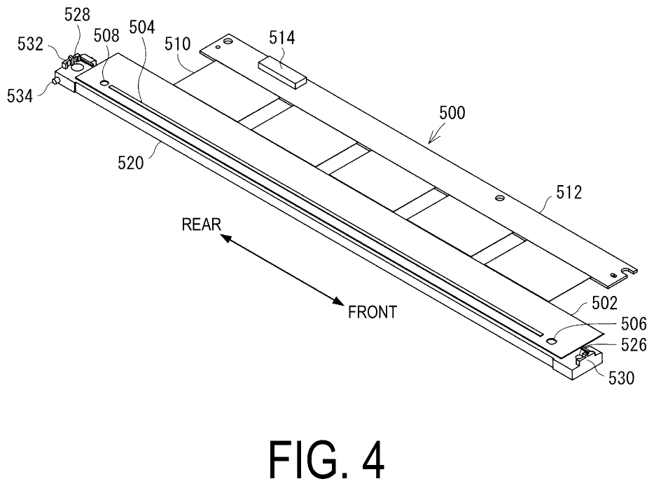

FIG. 4 illustrates the substrate unit 500 when the sheet-like substrate 502 is mounted to the support member 520 in the above-described manner. As understood by FIG. 4, the support member 520 is configured so that the dimension thereof in the longitudinal direction is larger than the dimension of the sheet-like substrate 502 in the longitudinal direction. Further, two positioning holes 526 and 528, which are different from those described above, are provided at appropriate positions outside both ends of the sheet-like substrate 502 in the longitudinal direction of the support member 520, in other words, positions close to both ends of the sheet-like substrate 502. The two positioning holes 526 and 528 are elements for positioning when a lens holder 540, which is described later, is mounted to the support member 520.

Furthermore, two regulating portions 530 and 532 each having a schematically wall-like shape are provided at appropriate positions outside the two positioning holes 526 and 528 in the longitudinal direction of the support member 520, specifically, at both end portions of the support member 520. The regulating portions 530 and 532 protrude upward in FIG. 3 and FIG. 4, and each have a constant dimension in a direction orthogonal to both the longitudinal direction of the support member 520 and the up-down direction in FIG. 3 and FIG. 4. Herein, description is made on a direction in which the exposure device 50 including the substrate unit 500 and the support member 520 is mounted to the image forming apparatus 10. The up-down direction of the substrate unit 500 and the support member 520 in FIG. 3 and FIG. 4 matches with the up-down direction of the image forming apparatus 10 at the time of mounting to the image forming apparatus 10. Therefore, the direction orthogonal to both the up-down direction in FIG. 3 and FIG. 4 and the front-rear direction in FIG. 3 and FIG. 4 corresponds to the left-right direction of the image forming apparatus 10.

Further, on the side surface close to the rear end portion of the support member 520, a rotation shaft 534 having a schematically columnar shape extending along the left-right direction of the image forming apparatus 10 is provided. Herein, although it is unclear from FIG. 3 and FIG. 4, the rotation shaft 534 is also provided on the side surface opposite to the side surface of the support member 520, which is illustrated in FIG. 3 and FIG. 4. In other words, the rotation shaft 534 is also provided on the right side surface of the support member 520.

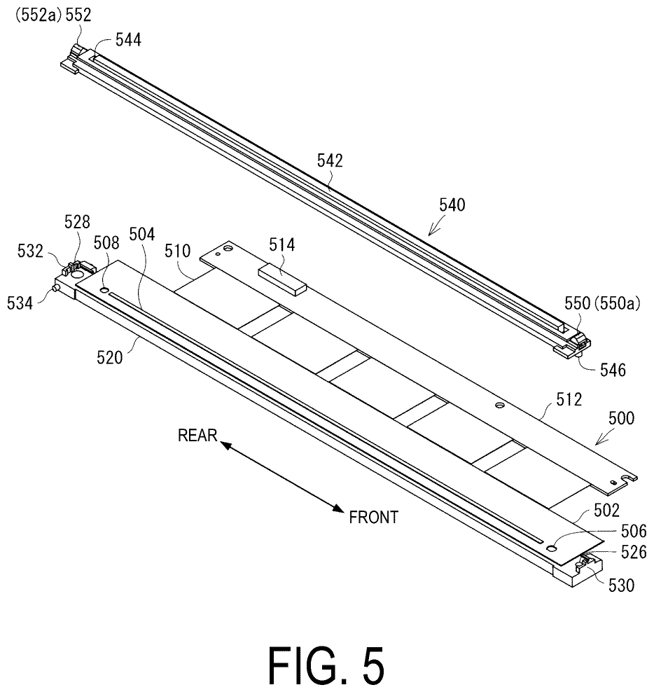

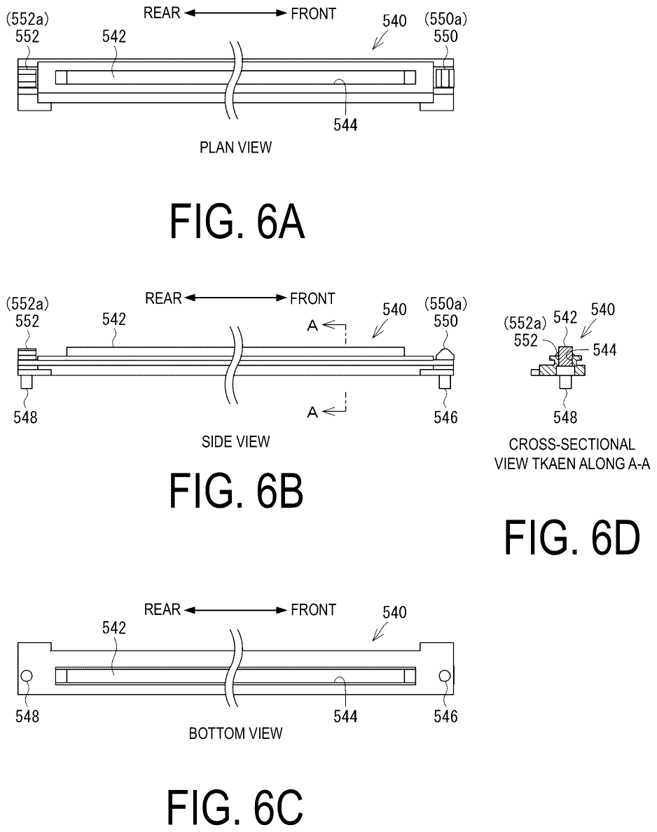

The lens holder 540 illustrated in FIG. 5 and FIGS. 6A to 6D is further mounted to the support member 520 to which the substrate unit 500 including the sheet-like substrate 502 is mounted in the above-mentioned manner. The lens holder 540 is an optical holding member that holds an optical member including of a plurality of lenses which form an image with light radiated (emitted) from a plurality of light-emitting elements provided on a sheet-like substrate onto a surface of a photoreceptor drum, such as a SELFOC (registered trademark) lens 542, and is an elongated member formed of, for example, a hard resin. Although it is unclear from the respective drawings including FIG. 5 and FIGS. 6A to 6D, the SELFOC lens 542 has a cylindrical shape, and is a lens array including a plurality of rod lenses each having a cylindrical refractive index distribution in which a refractive index varies parabolically from a central axis of the cylinder toward an outer peripheral portion, the rod lenses being arranged substantially linearly with the incident and emitting surfaces oriented in the same direction. The SELFOC lens 542 is a unity-magnification optical system lens in which a focal length on the incident-surface side and a focal length on the emitting-surface side are equivalent to each other. In other words, the SELFOC lens 542 is an optical component including a plurality of lenses that form an image with light emitted from the plurality of light-emitting elements onto the photoreceptor drum. Note that, in the present embodiment, the SELFOC lens 542 is configured so that the rod lenses are arranged in a single row. However, the SELFOC lens 542 may alternatively be configured so that the rod lenses are arranged substantially linearly in two or more rows. Further, in an external appearance, the SELFOC lens 542 has an elongated, substantially rectangular parallelepiped (prism-like) shape. The dimension of the SELFOC lens 542 in the longitudinal direction, in other words, the dimension corresponding to the array dimension of the rod lenses, is larger than the length dimension of the light-emitting element array 504.

The lens holder 540 includes a fitting portion 544 that holds the SELFOC lens 542 by fitting the SELFOC lens 542 therein. The fitting portion 544 is a through hole that passes through the lens holder 540 from the upper surface to the bottom surface, and the cross-section thereof orthogonal to the pass-through direction has a substantially rectangular shape. Further, the bottom surface of the lens holder 540 is flat, and this flat bottom surface serves as a facing portion that faces the upper surface of the support member 520 when the lens holder 540 is mounted to the support member 520. Furthermore, on the bottom surface of the lens holder 540, in the vicinity of both ends of the lens holder 540, two positioning protrusions 546 and 548 that correspond to the positioning holes 526 and 528 of the support member 520 and each have a schematically columnar shape are provided.

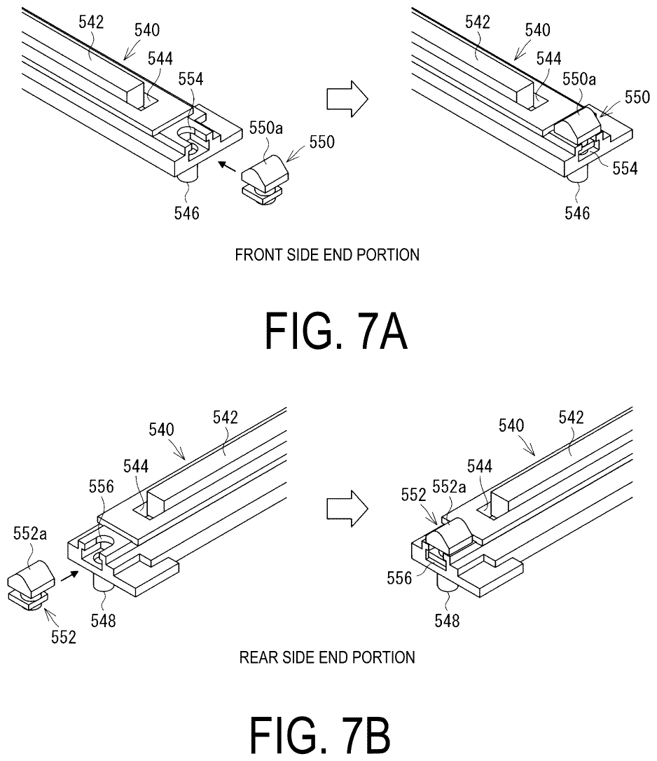

In addition, the positioning members 550 and 552 are provided in the upper part of the lens holder 540, at the positions close to both ends of the lens holder 540, specifically, directly above the respective positioning protrusions 546 and 548. With reference to FIGS. 7A and 7B, the positioning members 550 and 552 are members having the same specifications, and include protruding portions 550a and 552a each having a substantially triangular ridge shape. Further, each of the positioning members 550 and 552 is removably attached to the lens holder 540. Thus, on both end portions of the lens holder 540, mounting portions 554 and 556 to which the positioning members 550 and 552 are mounted are provided. Meanwhile, the positioning members 550 and 552 are mounted so that the extension directions of the protruding portions 550a and 552a are different from each other.

For example, the positioning member 550 on the front side is mounted to the mounting portion 554 on the front side so that the protruding portion 550a is oriented upward and the extension direction of the protruding portion 550a extends along the left-right direction. Meanwhile, the positioning member 552 on the rear side is mounted to the mounting portion 556 on the rear side so that the protruding portion 552a is oriented upward and the extension direction of the protruding portion 552a extends along the front-rear direction.

The lens holder 540 to which the positioning members 550 and 552 are mounted is mounted to the support member 520 while the sheet-like substrate 502 is sandwiched between the facing portion being the bottom surface of the lens holder 540 and the upper surface of the support member 520. In this state, the positioning protrusion 546 on the front side of the lens holder 540 is inserted (fitted) into the positioning hole 526 on the front side of the support member 520, and the positioning protrusion 548 on the rear side of the lens holder 540 is inserted (fitted) into the positioning hole 528 on the rear side of the support member 520. With this, positioning of the lens holder 540 with respect to the support member 520 is accurately performed. Further, the facing portion being the bottom surface of the lens holder 540 and the upper surface of the support member 520 are fixed by an adhesive (specifically, a double-sided tape).

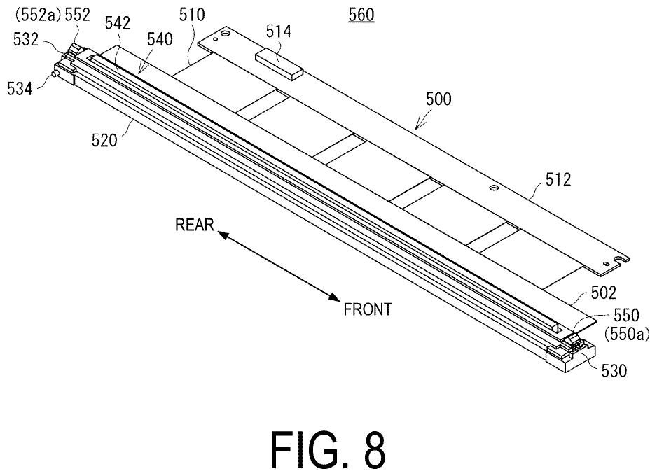

FIG. 8 illustrates a state in which the lens holder 540 is mounted to the support member 520 with the sheet-like substrate 502 therebetween. As understood from FIG. 8, the dimension of the lens holder 540 in the longitudinal direction is a dimension smaller than the dimension of the support member 520 in the longitudinal direction, specifically, a dimension that perfectly fits inside the two regulating portions 530 and 532 provided to both end portions of the support member 520. Further, the mounting portions 554 and 556 provided to both end portions of the lens holder 540 are closed by the regulating portions 530 and 532. With this, outward movement of the positioning members 550 and 552 mounted to the mounting portions 554 and 556 is regulated. Consequently, the positioning members 550 and 552 are prevented from coming off from the mounting portions 554 and 556.

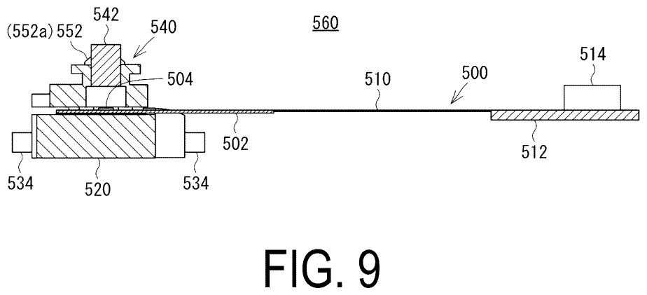

Note that, as illustrated in FIG. 8, the state in which the lens holder 540 is mounted to the support member 520 with the sheet-like substrate 502 therebetween is referred to as an exposure unit main body 560. Further, FIG. 9 illustrates a cross-sectional view obtained by cutting the vicinity of the center of the exposure unit main body 560 in the front-rear direction by an imaginary plane orthogonal to the front-rear direction.

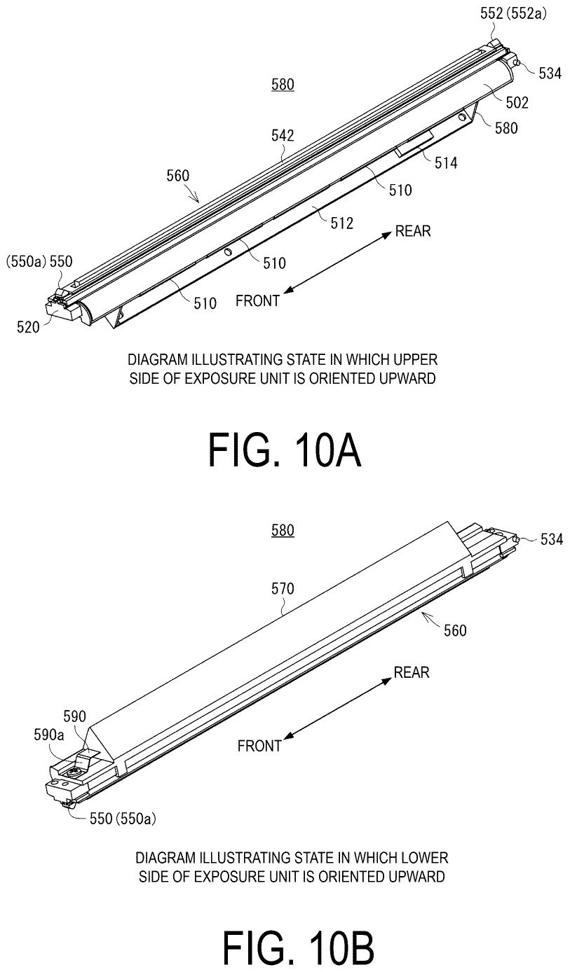

An exposure unit 580 is achieved by mounting the exposure unit main body 560 to an appropriate exposure unit frame 570 as illustrated in FIGS. 10A and 10B. A spring member 590 having a plate-like shape, which is described later, is provided at an appropriate position on the front side of the exposure unit frame 570, and is fixed by a screw, for example.

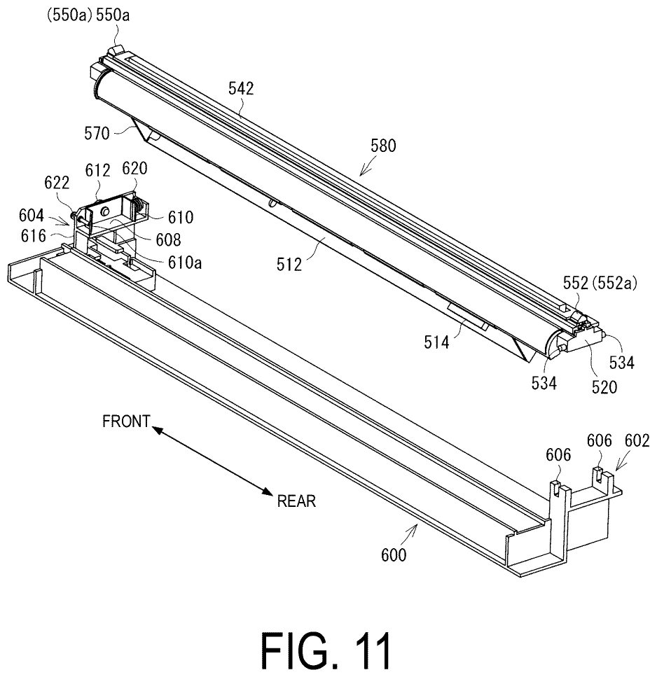

Furthermore, an exposure device frame 600 illustrated in FIG. 11 is mounted to the exposure unit 580. Thus, the exposure device 50 is obtained. A rear support portion 602 for supporting the rear side of the exposure unit 580 is provided on the rear side of the exposure device frame 600, and a front support portion 604 for supporting the front side of the exposure unit 580 is provided on the front side of the exposure device frame 600.

While focusing on the rear support portion 602, the rear support portion 602 includes two rotation shaft support portions 606 and 606 each having a substantially U-like shape for supporting the two rotation shafts 534 and 534 described above. In other words, by accommodating the rotation shafts 534 and 534 in the rotation shaft support portions 606 and 606, the rear side of the exposure unit 580 is supported. In other words, the exposure unit 580 is rotatably supported about the rotation shafts 534 and 534 as the rotation centers.

Meanwhile, the front support portion 604 includes a table portion 608 on which the front side of the exposure unit 580 is placed. In other words, when the front side of the exposure unit 580 is placed on the table portion 608, the front side of the exposure unit 580 is supported by the front support portion 604 including the table portion 608. Furthermore, the front support portion 604 includes a surrounding member 610 provided so as to surround both the left and right side surfaces on the front side of the exposure unit 580 placed on the table portion 608.

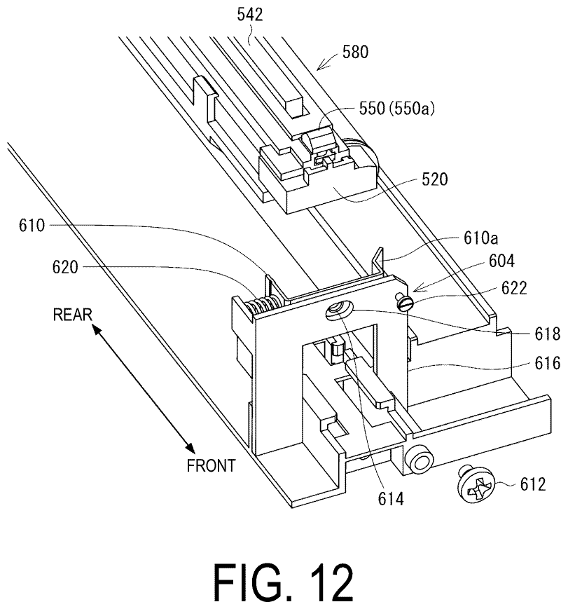

With reference to FIG. 12, as viewed from above, the surrounding member 610 has a substantially U-like shape. Further, when the front side of the exposure unit 580 is placed on the table portion 608, the front side of the exposure unit 580 is accommodated in the space surrounded by the surrounding member 610, in other words, the surrounding member 610 surrounds both the left and right side surfaces of the front side of the exposure unit 580. Further, the surrounding member 610 includes a screw hole 614 into which a fixing screw 612 is screwed. The fixing screw 612 is screwed into the screw hole 614 of the surrounding member 610 via a through hole 618 provided in a wall-like base portion 616 forming the front support portion 604. Therefore, while the front side of the exposure unit 580 is surrounded by the surrounding member 610, in other words, the front side of the exposure unit 580 is placed on the table portion 608, the fixing screw 612 screwed into the screw hole 614 of the surrounding member 610 is tightened. In this state, the distal end of the fixing screw 612 applies a pressing force onto the front end portion of the exposure unit 580 (the support member 520). As a result, the exposure unit 580 is fixed, in other words, mounted to the exposure device frame 600. Note that the through hole 618 is an elongated hole extending along the left-right direction.

In addition, the surrounding member 610 is in a state of being biased to the right side by a pressing spring provided to the left side surface. At the same time, a part of the right side surface of the surrounding member 610 extends obliquely rearward to the right. With this, an inclined portion 610a extending obliquely rearward to the right is formed. Further, a distal end of an adjustment screw 622 mounted to the wall-like base portion 616 abuts against the inclined portion 610a, in other words, is configured so that such a state is achieved. Therefore, the adjustment screw 622 is rotated while the fixing screw 612 is loosened, and the front side of the exposure unit 580 is displaced in the left-right direction. With this, the exposure direction of the exposure unit 580 with respect to the rotation axis direction of the photoreceptor drum 46, and so-called screw adjustment can be performed. In other words, the front support portion 604 also functions as a skew adjustment mechanism.

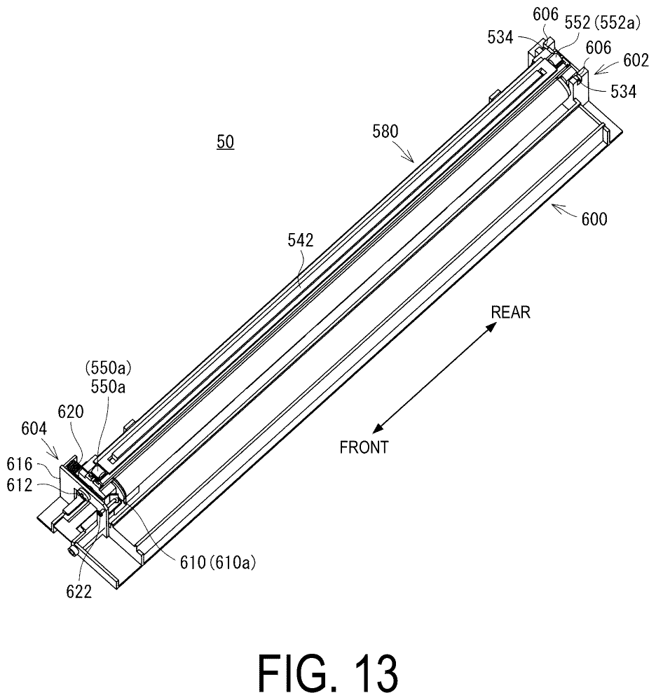

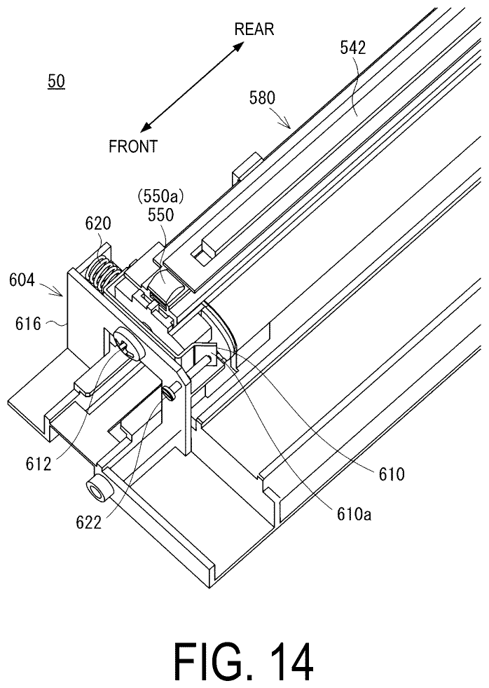

FIG. 13 illustrates a state in which the exposure unit 580 is mounted to the exposure device frame 600, in other words, an external appearance of the exposure device 50. Further, FIG. 14 is a diagram illustrating the front side of the exposure device 50 in an enlarged manner.

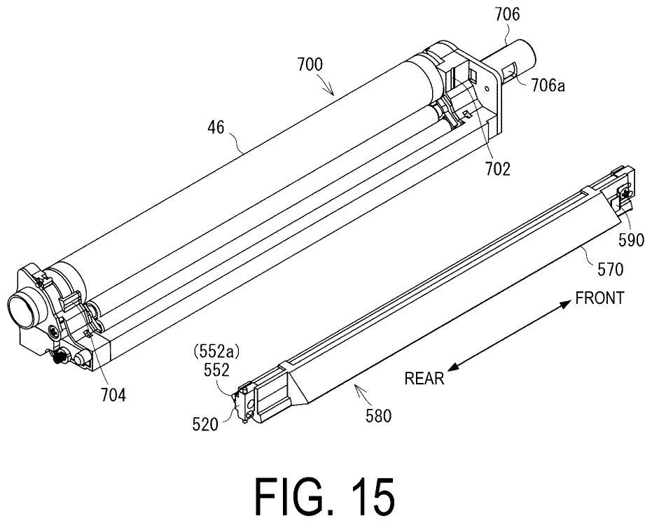

The exposure device 50 is positioned with respect to the photoreceptor drum 46. Thus, as illustrated in FIG. 15, a photoreceptor unit 700 including the photoreceptor drum 46 is provided with the positioning engagement portions 702 and 704 that are engaged with the protruding portions 550a and 552a of the positioning members 550 and 552 of the exposure device 50 (the lens holder 540). The positioning engagement portion 702 on the front side has a configuration suitable for engagement with the protruding portion 550a on the front side of the positioning member 550. Specifically, the positioning engagement portion 702 is a groove that extends along the extension direction of the protruding portion 550a, in other words, the left-right direction, and has a shape and a size corresponding to the shape and the size of the distal end of the protruding portion 550a. Further, the positioning engagement portion 704 on the rear side has a configuration suitable for engagement with the protruding portion 552a on the rear side of the positioning member 552. Specifically, the positioning engagement portion 704 is a groove that extends along the extension direction of the protruding portion 552a, in other words, the front-rear direction, and has a shape and a size corresponding to the shape and the size of the distal end of the protruding portion 552a. Note that, in FIG. 15, for easy understanding of a mutual correlation between the respective positioning engagement portions 702 and 704 of the photoreceptor unit 700 and the respective positioning members 550 and 552 of the exposure device 50, the exposure unit 580 is also illustrated. Further, on the front side of the photoreceptor unit 700, a waste toner discharge portion 706 for discharging waste toner is provided. Waste toner is discharged from a discharge port 706a of the waste toner discharge portion 706 to the waste toner container 100.

Herein, the photoreceptor unit 700 is removably attached to the main body of the image forming apparatus 10. In this case, it is required to remove the waste toner container 100 described above from the main body of the image forming apparatus 10. Further, when the waste toner container 100 is removed from the main body of the image forming apparatus 10, positioning of the exposure device 50 with respect to the photoreceptor drum 46 is canceled, and a state in which the exposure device 50 is separated away from the photoreceptor unit 700 is achieved, for example. In such a state, the photoreceptor unit 700 can be removed from the main body of the image forming apparatus 10. In contrast, when the waste toner container 100 is mounted to the main body of the image forming apparatus 10, the protruding portions 550a and 552a of the positioning members 550 and 552 of the exposure device 50 and the positioning engagement portions 702 and 704 of the photoreceptor unit 700 are engaged with each other, and the exposure device 50 is positioned with respect to the photoreceptor drum 46. In other words, the exposure device 50 is in a state of being engaged with the photoreceptor unit 700. Moreover, the transition between those states is automatically performed in response to removal and attachment of the waste toner container 100 with respect to the main body of the image forming apparatus 10.

Specifically, as illustrated in FIGS. 16A and 16B, the exposure device 50 includes a moving member 630 that moves in the front-rear direction in response to removal and attachment of the waste toner container 100. Note that the waste toner container 100 is removed from the front side of the main body of the image forming apparatus 10, and is mounted to the front side of the main body of the image forming apparatus 10. Further, the discharge port 706a of the waste toner discharge portion 706 described above is provided with a shutter (not illustrated). For example, as illustrated in FIG. 16A, when the waste toner container 100 is not mounted, the shutter is closed. Further, as illustrated in FIG. 16B, when the waste toner container 100 is mounted, the shutter is opened, and waste toner is discharged from the waste toner discharge portion 706 to the waste toner container 100 via the discharge port 706a.

The moving member 630 is in a state of being urged forward by a compression spring 632. Thus, when the waste toner container 100 is not mounted, the moving member 630 moves forward by an urging force of the compression spring 632. Further, when the waste toner container 100 is mounted, the moving member 630 is pushed rearward by the waste toner container 100 against an urging force of the compression spring 632. Then, an appropriate pressing portion 634 mounted to the moving member 630 abuts against the spring member 590, and pushes the exposure device 50 including the spring member 590 upward. With this, the exposure device 50 rotates about the two rotation shafts 534 and 534, which are described above, as the rotation centers. Then, the protruding portion 550a of the positioning member 550 on the front side of the exposure device 50 is engaged with the positioning engagement portion 702 on the front side of the photoreceptor unit 700. Further, (although it is unclear from FIGS. 16A and 16B), the protruding portion 552a of the positioning member 552 on the rear side of the exposure device 50 is engaged with the positioning engagement portion 704 on the rear side of the photoreceptor unit 700. As a result, the exposure device 50 is positioned with respect to the photoreceptor drum 46, and the exposure device 50 is in a state of being engaged with the photoreceptor unit 700. Note that the waste toner container 100 is locked by a stopper (not illustrated) so that the waste toner container 100 mounted to the main body of the image forming apparatus 10 is prevented from coming off from the main body of the image forming apparatus 10.

As described above, the protruding portion 550a of the positioning member 550 on the front side of the exposure device 50 extends along the left-right direction. In accordance with this, the positioning engagement portion 702 on the front side of the photoreceptor unit 700 also extends along the same left-right direction. Therefore, for example, even when skew adjustment is performed by the skew adjustment mechanism achieved by the front support portion 604 of the exposure device 50, in other words, the front side of the exposure unit 580 is displaced in the left-right direction, positioning of the exposure device 50 with respect to the photoreceptor drum 46 is achieved accurately.

Meanwhile, the protruding portion 552a of the positioning member 552 on the rear side of the exposure device 50 extends along the front-rear direction. In accordance with this, the positioning engagement portion 704 on the rear side of the photoreceptor unit 700 also extends along the front-rear direction. Therefore, for example, even when there is an individual variation in the mutual distance between the positioning member 550 on the front side and the positioning member 552 on the rear side of the exposure device 50, an error including the individual variation is absorbed. This also significantly contributes to accurate positioning of the exposure device 50 with respect to the photoreceptor drum 46.

Furthermore, while focusing on the spring member 590, the spring member 590 includes an inclined portion 590a protruding obliquely rearward to the lower side. Therefore, when the pressing portion 634 of the moving member 630 abuts against the spring member 590, the pressing portion 634 first abuts against the inclined portion 590a of the spring member 590. With this, the pressing portion 634 can smoothly push the exposure device 50 including the spring member 590 upward. Further, after the exposure device 50 including the spring member 590 is sufficiently pushed upward, this state is maintained due to elasticity of the spring member 590, in other words, the configuration is achieved so as to maintain the state. Note that the pressing portion 634 is, for example, a member having a substantially rectangular parallelepiped shape, and the part that abuts against the spring member 590 has a chamfered shape. This also contributes to smooth upward pushing of the exposure device 50 including the spring member 590.

Further, when the waste toner container 100 is removed, the moving member 630 moves forward by an urging force of the compression spring 632. Then, the abutting state of the pressing portion 634 against the spring member 590 is canceled, and the exposure device 50 including the spring member 590 is lowered due to its own weight, strictly speaking, rotates about the two rotation shafts 534 and 534 as the rotation centers. With this, the engagement state between the protruding portion 550a of the positioning member 550 on the front side of the exposure device 50 and the positioning engagement portion 702 on the front side of the photoreceptor unit 700 is canceled. Also, (although it is unclear from FIGS. 16A and 16B), the engagement state between the protruding portion 552a of the positioning member 552 on the rear side of the exposure device 50 and the positioning engagement portion 704 on the rear side of the photoreceptor unit 700 is also canceled. As a result, positioning of the exposure device 50 with respect to the photoreceptor drum 46 is canceled, and the exposure device 50 is in a state of being separated away from the photoreceptor unit 700.

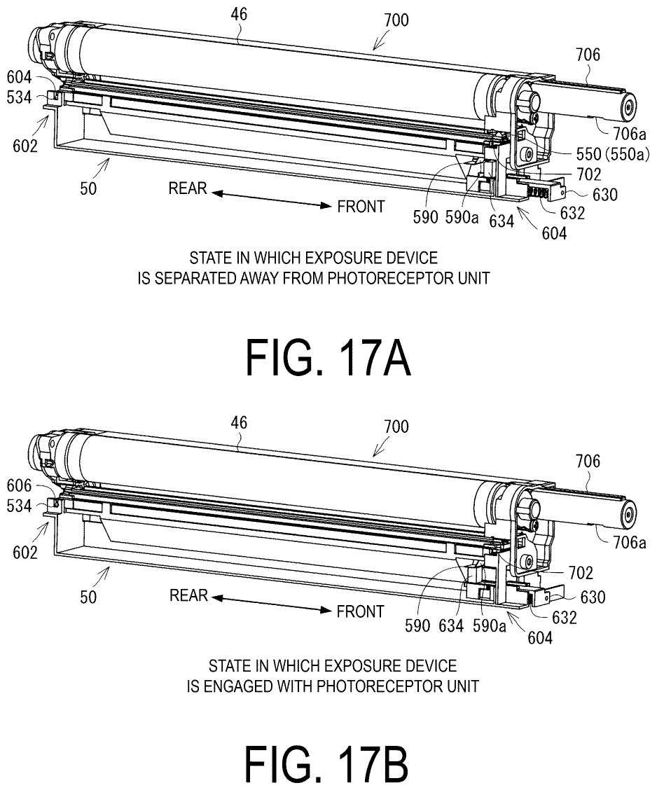

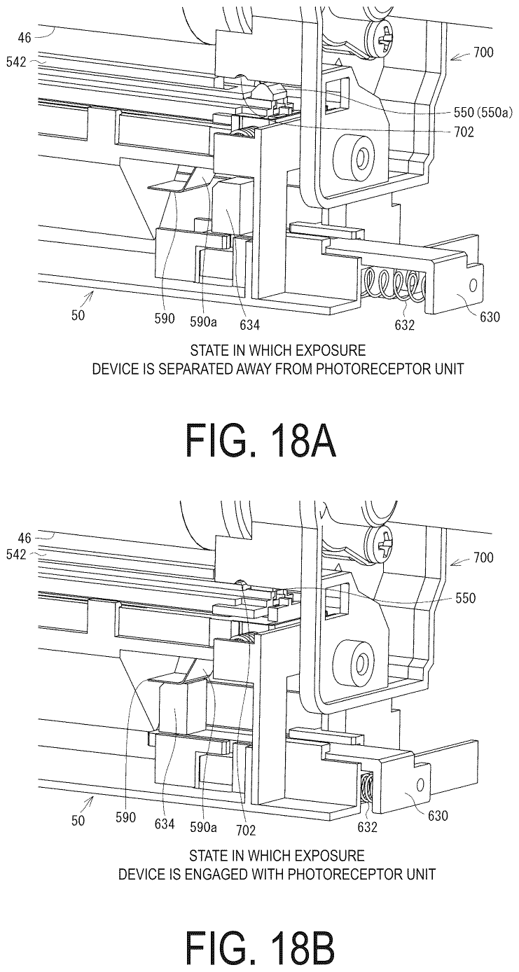

Note that, in FIGS. 16A and 16B, for clarity of illustration, the exposure device frame 600 is omitted in the illustration, and some elements such as the waste toner container 100 and the moving member 630 are schematically illustrated. A specific configuration including the exposure device frame 600 is illustrated in FIGS. 17A and 17B. Further, FIGS. 18A and 18B are diagrams illustrating the front side in the configuration illustrated in FIGS. 17A and 17B in an enlarged manner. However, in FIGS. 17A, 17B, 18A and 18B, the waste toner container 100 is omitted in the illustration.

As described above, according to the present embodiment, the lens holder 540 is mounted while the sheet-like substrate 502 is sandwiched between the lens holder 540 and the upper surface of the support member 520. In this state, the two positioning protrusions 546 and 548 provided to the lens holder 540 are inserted into the two positioning holes 526 and 528 provided to the support member 520. With positioning of the lens holder 540 with respect to the support member 520 is achieved accurately. At the same time, the two positioning members 550 and 552 for positioning with respect to the photoreceptor drum 46 are provided to the lens holder 540. Therefore, even in a configuration in which the light-emitting element array 504 is provided to the sheet-like substrate 502, which is a flexible substrate, the distance from the light-emitting element array 504 to the SELFOC lens 542 being an optical member can be controlled at high accuracy. Consequently, the distance from the light-emitting element array 504 to the surface of the photoreceptor drum 46 being an exposure target member can be controlled at high accuracy. Moreover, such distinctive actions and effects can be achieved by means of a simple configuration.

Note that the lens holder 540 in the present embodiment is an example of the optical holding member according to the present disclosure. Further, the positioning members 550 and 552 of the lens holder 540 in the present embodiment are an example of the first positioning portion according to the present disclosure. Furthermore, the protruding portion 550a of the positioning member 550 on the front side in the present embodiment is an example of the first protrusion according to the present disclosure, and the protruding portion 552a of the positioning member 552 on the rear side in the present embodiment is an example of the second protrusion according to the present disclosure. Further, the positioning protrusions 546 and 548 of the lens holder 540 in the present embodiment are an example of the second positioning portion according to the present disclosure. In addition, the front support portion 604 that also functions as the skew adjustment mechanism is an example of the displacement mechanism according to the present disclosure.

The present embodiment is one specific example of the present disclosure, and does not limit the technical scope of the present disclosure. The present disclosure can be applied to aspects other than the present embodiment.

For example, with regard to the positioning member 550 on the front side of the lens holder 540, mounting is performed so that the protruding portion 550a extends in the left-right direction. With regard to the positioning member 552 on the rear side thereof, mounting is performed so that the protruding portion 552a extends in the front-rear direction. However, this relationship may be opposite. In other words, with regard to the positioning member 550 on the front side, mounting may be performed so that the protruding portion 550a extends in the front-rear direction. With regard to the positioning member 552 on the rear side, mounting may be performed so that the protruding portion 552a extends in the left-right direction. In such a case, for the positioning engagement portions 702 and 704 on the photoreceptor unit 700 side, the configuration (especially, the extension direction) in accordance with the respective protruding portions 550a and 552a of the positioning members 550 and 552 is also required.

Further, each of the positioning members 550 and 552 of the lens holder 540 may be configured integrally with (the main body of) the lens holder 540.

Furthermore, the shape of each of the positioning members 550 and 552 has a substantially triangular ridge shape (has a triangular cross-section taken along an imaginary plane orthogonal to its extending direction), and is not limited thereto. In other words, as long as the actions and effects similar to those exerted when a substantially triangular ridge shape is adopted can be exerted, the shape of each of the positioning members 550 and 552 is not limited to a substantially triangular ridge shape. In such a case, for the positioning engagement portions 702 and 704 on the photoreceptor unit 700 side, the configuration corresponding to the shapes of the respective positioning members 550 and 552 is also required.

In addition, in the embodiment described above, the configuration in which an organic EL array is adopted as the light-emitting element array 504 is given as an example. However, the present disclosure is also applicable to a configuration in which one other than an organic EL array is adopted as the light-emitting element array 504.

Further, in addition, in the embodiment described above, the configuration in which the SELFOC lens 542 is adopted as the optical member is given as an example. However, the present disclosure is also applicable to a configuration in which one other than the SELFOC lens 542 is adopted as the optical member.

Further, in the embodiment described above, the image forming apparatus 10 employing the color image former 26 of a tandem type has been described as an example. However, the disclosure can also be applied to an image forming apparatus employing a color image former of a rotary type. As a matter of course, the disclosure is also applicable to a monochrome image forming apparatus.

Further, the image forming apparatus 10 in the embodiment described above is a multifunction peripheral. However, the present disclosure is also applicable to an image forming apparatus other than the multifunction peripheral, such as a dedicated printing machine, a dedicated copy machine, or a dedicated fax machine.

While there have been described what are at present considered to be certain embodiments of the invention, it will be understood that various modifications may be made thereto, and it is intended that the appended claim cover all such modifications as fall within the true spirit and scope of the invention.

What is claimed is:

1. An exposure device that exposes an exposure target member, the exposure device comprising:
a substrate having flexibility and a sheet-like shape and including one main surface on which a plurality of light-emitting elements are arranged in a substantially linear shape;
a support member being provided on the other main surface side of the substrate; and
an optical holding member holding an optical member formed of a plurality of lenses that image light emitted from the plurality of light-emitting elements onto the exposure target member, and being provided on the one main surface side of the substrate while a longitudinal direction of the optical member extends along an array direction of the plurality of light-emitting elements, wherein
the optical holding member is positioned at the support member while sandwiching the substrate between the support member and the optical holding member, and
a first positioning portion that positions the optical holding member with respect to the exposure target member and a second positioning portion that positions the optical holding member with respect to the support member are provided to the optical holding member at positions outward of both ends of the optical member in the longitudinal direction of the optical member.

2. The exposure device according to claim 1, wherein
the first positioning portion includes:
a first protrusion that is provided on one end side of the optical member, protrudes in an imaging direction of the light by the optical member, and extends along a direction orthogonal to both the imaging direction of the light and the longitudinal direction of the optical member; and
a second protrusion that is provided on the other end side of the optical member, protrudes in the imaging direction of the light, and extends along the longitudinal direction of the optical member.

3. The exposure device according to claim 2, further comprising:
a displacement mechanism that displaces a unit including the substrate, the support member, and the optical holding member along an extension direction of the first protrusion.

4. An image forming apparatus comprising:
the exposure device according to claim 1.

5. The image forming apparatus according to claim 4, wherein
the support member includes, on a side corresponding to one of both ends of the optical member, a rotation shaft that protrudes in a direction orthogonal to both the longitudinal direction of the optical member and the imaging direction of the light by the optical member, and includes, on a side corresponding to the other of both ends of the optical member, an inclined portion that protrudes obliquely toward a side opposite to the side on which the substrate is provided,
the image forming apparatus further comprising:
an image carrier that serves as the exposure target member,
a waste toner container that is removably attached to an image forming apparatus main body; and
a moving member that moves along the longitudinal direction of the optical member as the waste toner container is removed and attached with respect to the image forming apparatus main body, and
when the moving member moves as the waste toner container is mounted with respect to the image forming apparatus main body, the moving member abuts against the inclined portion, and the support member rotates about the rotation shaft as a rotation center, and then positioning with respect to the image carrier by the first positioning portion is achieved.

6. The image forming apparatus according to claim 5, wherein
the inclined portion is formed of a spring having a plate-like shape.
